(19) United States
(12) Patent Application Publication
(10) Pub. No.: US 2021/0068354 A1
(43) Pub. Date: Mar. 11, 2021

(54) ENVIRONMENTAL CONTROL SYSTEM

(71) Applicant: Co2i Limited, Haddenham, Aylesbury (GB)

(72) Inventor: Brendan Cawley, Haddenham, Aylesbury (GB)

(73) Assignee: Co2i Limited, Haddenham, Aylesbury (GB)

(21) Appl. No.: 16/643,394

(22) PCT Filed: Aug. 30, 2018
(86) PCT No.: PCT/GB2018/052457

§ 371 Date: Feb. 28, 2020

(30) Foreign Application Priority Data
Aug. 31, 2017 (GB) 1713931.2

(51) Int. Cl. A01G 9/16; A01G 9/22; A01G 9/24

(52) U.S. Cl. CPC A01G 9/16; A01G 9/22; A01G 9/1407; A01G 9/249; A01G 9/247

(57) ABSTRACT

The invention relates to a greenhouse, specifically a closed greenhouse environment suitable for use in dry environments which regulates the conditions of the growing environment whilst minimising heat and water loss. The greenhouse is especially suitable for use with macrophyte growing systems.

### FIELD OF INVENTION

The present invention relates to a greenhouse comprising an arrangement for providing a closed system, particularly though not exclusively for providing a controlled atmosphere in the closed system when the greenhouse is located in hostile growing surroundings.

### BACKGROUND TO THE INVENTION

It is well established that there are significant food shortages around the world and that this problem is likely to increase as the climate becomes less hospitable. The land available for conventional agriculture is also becoming smaller as the climate changes.

Accordingly, there is a demand for innovative approaches to improving food yields and making better use of the earth's surface for agricultural purposes. One particular region of interest are deserts. A desert is typically characterised as a barren area with little precipitation, it does not necessarily need to be hot. Most non-polar deserts receive large amounts of sunlight throughout the year. Although this sunlight is very good for promoting photosynthesis, it typically removes any trace of water from the environment. Moreover, the world's deserts are expanding every year as the Earth's climate becomes warmer. These non-polar deserts also tend to have a substantial variation in temperature with many fluctuating as much as 15° C. to 20° C. in a single day. These factors pose a significant challenge to plants.

It is possible to prevent evaporative water loss in such environments by shielding crops within an enclosed system having a regulated atmosphere, usually in a greenhouse. This not only prevents evaporative water loss to the atmosphere (i.e. of water vapour) but also prevents the escape of liquid water through the ground.

In terms of assembly and installation of a greenhouse, such environments may have access difficulties, requiring components prior to assembly to be transported long distances. Moreover, such environments are typically not connected to a reliable grid source of electricity. Accordingly, any required electrical power must then be supplied by means of a portable generator or battery source. Further, in some parts of the world, electrical power is not reliable.

There is a need for a system for controlling the temperature, humidity and carbon dioxide conditions in an enclosed growing environment suitable for installation in a desert-like environment.

The invention is intended to address or at least ameliorate the above problems.

### SUMMARY OF THE INVENTION

According to a first aspect of the invention, there is provided a greenhouse comprising: a first sub-assembly, the first sub-assembly comprising: a rail comprising a first clamping means; a cover configured to at least partially allow light therethrough; and a liner; wherein the first sub-assembly, the cover and the liner cooperate with each other so as to form a closed system. The purpose of the clamping means is to hold the cover and/or the liner in position with respect to the rail so that, the rail, the cover and the liner form a closed system. There is no particular restriction as to how the clamping means function and this may be achieved using adhesives, weight, ultrasonic welding, stapling, or other interference-fit geometries such as a one way geometric or frictional resistance.

Typically, the first clamping means is provided as; a first receiving portion in the rail, and a first insert configured to be received in the first receiving portion such that, in use, the cover and/or liner is clamped between the cavity of the first receiving portion and the first insert.

This arrangement has the advantage of providing a closed system which is simple and easy to assemble. Such advantages are particularly useful when assembling the greenhouse in a difficult environment, such as a desert. Such an arrangement also has the advantage of providing a reliable seal between components and a reliable closed system.

The term “closed system” as used herein is intended to mean an enclosed environment such that the growing atmosphere, and preferably the entire growing environment is unable to communicate (i.e. come into physical contact) with the external environment. This prevents the air within the greenhouse from escaping and hence, prevents the loss of heat via convection. It also prevents the loss of valuable growth materials present in the air such as water vapour, oxygen, CO2 and the like. This also prevents water and nutrients escaping through the base of the greenhouse. Whilst it is preferable that the greenhouse recirculates the atmosphere and/or fluid within the greenhouse between the growing chamber and the air treatment system in a continuous loop, this is not essential. It may also be the case that the greenhouse comprises a gas exchange mechanism i.e. a system for conducting regulated introduction of air from the environment into the greenhouse and/or expulsion of air from the greenhouse to the environment. This can be achieved using valves and other method familiar to the skilled person. Such systems provide an alternative method of controlling the conditions within the greenhouse without permitting free flow between the growing environment and the external environment.

The term “greenhouse” is not intended to be construed as exclusively encompassing glass structures but to cover any structure for growing crops. There is no minimum size nor specific dimensions associated with said greenhouse. Typically, the greenhouse may have a depth of greater than 0.25 m, more often in the range 0.3 m to 5.0 m, preferably in the range 0.5 m to 4.0 m, more preferably in the range 0.5 m to 3 m. Typically, the greenhouse may have a depth in the range 0.4 to 2 m and more ideally 0.5 to 1 m. Typically, such a greenhouse may be of 50 m or more in length, more typically having a length in the range 50 m to 2 km, more usually 100 m to 1 km, preferably in the range 500 m to 750 m, more preferably in the range 600 m to 800 m and more preferably still in the range 150 m to 500 m. Often the greenhouse will have a length in the range 50 m to 200 m. Typically, such a greenhouse may have a width in the range 10 m to 100 m, preferably in the range 50 m to 60 m, and is often in the range 13 m to 50 m, and sometime in the range 10 m to 30 m or more typically in the range 8 m to 20 m. There is no requirement for the greenhouse to be made substantially, or even partially, of a transparent material. However, it is typically the case that the greenhouse will comprise transparent portions in order to permit light to reach the crops contained therein. As stated above, the greenhouse comprises a first sub-assembly, a cover and a liner which cooperate with each other so as to form a closed system defining a growing chamber in which plant growth can occur. The first sub-assembly, the cover and the liner may include thermal insulation to avoid heat loss, for instance in the form of padded material or integral air pockets within the first sub-assembly, the cover, the liner, and/or in components surrounding the closed system. In addition, the greenhouse may also have regions adapted to radiate or absorb heat in situations where the internal temperature of the greenhouse exceeds or approaches the upper limit of acceptable temperature conditions. These could be portions of thermally conductive material in contact with the external environment. Such portions could be portions of the first sub-assembly, the cover, the liner or combinations thereof which may have geometries adapted to maximise surface area of the greenhouse in order to enhance the rate of heat transfer.

The entire first sub-assembly and cover of the greenhouse may be made from a transparent material or may comprise a plurality of windows made from transparent material. The choice of transparent material used is not limited to glass. Typically the cover is made from a transparent material. Any transparent material would be sufficient provided it can be manufactured into a suitable shape. For example, any material with an amorphous crystal structure may be suitable. Often, transparent polymeric materials are used as the transparent material. Multiple layers of material may be used and/or laminated together. Moreover, the materials may be customised or coated so as to promote condensation, anticondensation, antifouling, and other properties familiar to the person skilled in the art. The skilled person would be familiar with a variety of typical polymers suitable for such purposes such as polyethylene or polypropylene or derivatives thereof. It is typically the case that a flexible polymer will be used as such materials can be easily transported and often have better performance and durability in desert conditions. For instance, glass can be more prone to scratching in high winds which can compromise optical properties, and can be susceptible to fracture during transport. A non-brittle and tough material is preferable. Moreover, shattered glass can end up in the growing environment and present a hazard. The transparent material, specifically the transparent material of the cover, may be reinforced or modified to control the reflectance of the material or augment the thermal properties of the material. Shading could also be employed to control the amount of sunlight incident on the external surfaces of the greenhouse at certain times of the day. Such shading may be provided by a screen either within the greenhouse or external of the greenhouse, typically located externally.

The liner is typically fabricated from a robust waterproof material to cope with containing a fluid bed. Typical examples of materials suitable for this task include, but are not limited to: polyethene (i.e. polyethylene), PVC, rubbers, or combinations thereof.

The rail may further comprise a second clamping means spaced from the first clamping means. Typically, the second clamping means is provided as a second receiving portion in the rail; and a second insert configured to be received in the second receiving. This has the advantage of providing two sealable parts on the rail, between which a feature can be attached or included. In this configuration, such a feature is inside the closed system.

The first receiving portion and the first insert of the first sub-assembly may cooperate by means of a snap-fit connection or interference-fit connection. The second receiving portion and the second insert of the first sub-assembly may also cooperate by means of a snap-fit connection or interference-fit connection. A snap-fit connection or interference-fit connection is achieved by the insert having a wider diameter than the diameter of the opening of the receiving portion. The receiving portion is configured to elastically deform upon partial insertion of the insert, and to at least partially elastically deform back to a less elastically deformed position upon full insertion of the insert. The process of elastic deformation at least partially back to the original position is often referred to as a “snap” back. Upon full insertion of the insert, the receiving portion may be in its original state, i.e. unstressed at a macroscopic level. In a fully inserted state, there is an energy barrier for removal of the insert from the receiving portion. As such, the insert and the receiving portion are fixedly attached by means of the snap-fit connection. An interference-fit connection is similar to the snap-fit connection described above and is also envisaged in the present invention. It is achieved by the insert having a wider diameter than the diameter of the opening of the receiving portion. However, the insert is configured to elastically deform upon partial insertion into the receiving portion, and the insert at least partially elastically deforms back to a less elastically deformed position upon full insertion into the receiving portion. Accordingly, the insert (when full inserted) resiliently presses against the receiving portion thereby trapping any material contained therein. Moreover, in either of the two mechanisms described, more than one insert may be used per receiving portion.

Whilst the clamping means are often a snap-fit or interference-fit connection, the clamping means used to form the closed system in conjunction with the liner and cover may use other techniques. For example, such techniques may include: welding, adhering, roll seaming, sewing or combinations thereof.

The cover and liner may be joined together using welding. As the cover and liner are typically polymeric materials, said welding is using thermal or ultrasonic welding to create a seam between the cover and line. Alternatively, an adhesive can be used to bond the ends of the cover and liner together thereby sealing the growing chamber. Adhesive may also be used to bond the joined cover/liner to a rail. A seam may also be created to hold the ends of the cover and liner in contact with each other, which may take the form of a rolled seam, a sewn seam or other similar joining techniques. The joined ends of the cover and liners can then be affixed to the rail or, in some embodiments, affixed directly to a pillar or gutter.

At least a portion of the cover may be clamped by the first clamping means, and more typically between the first receiving portion and the first insert. In the clamped state, the cover may be at least partially between the first receiving portion and the first insert when the first insert is fully inserted into the first receiving portion. The arrangement incorporating a snap-fit connection between the first receiving portion and the first insert has the advantage of providing a closed system which is simple and easy to assemble. Such an arrangement also has the advantage of providing a reliable seal between components and a reliable closed system, without the need for small components such as screws and separate attachments. A portion of the liner may be clamped by the second clamping means, and more typically between the second receiving portion and the second insert. This is advantageous as it allows the liner to be easily connected into the rail of the sub-assembly. As such, each of the cover, the rail and the liner together can be connected so as to efficiently form a closed system. In some embodiments, the cover and the liner are the same component. In particular, one end of the cover may be connected to the first clamping means (typically the first receiving portion) and the other end of the cover may connect to the second clamping means (typically the second receiving portion) thereby defining a growing chamber.

Typically; the rail, the first clamping means and the second clamping means (typically the first insert and the second insert) each independently comprise a metal, typically steel or aluminium (often steel is used). The components of the clamping means do not need to be fabricated from the same material. The receiving portion (which may be part of the rail) may be made from steel and the insert may be made of aluminium. Alternatively, the insert could be made from plastics, or any elastically deformable material, and the receiving portion be fabricated from aluminium. Using steel, especially cold rollable steel, is advantageous because it may be fabricated by extrusion, forming or another suitable on-site manufacturing techniques. For example, the rail and/or first insert could be extruded, rolled, laid or otherwise deployed on site. Alternatively or in addition; the rail, the first clamping means and second clamping means (typically the first insert and the second insert) each independently comprise a protective coating. Coatings can be applied to improve the rust resistance of the materials, enhance the reflectiveness of the walls of the system, or otherwise modify the surface properties of the rail, the first insert and/or the second insert.

Further, the first receiving portion, the second receiving portion, the first insert and the second insert may each independently be elongate. The first and/or second insert may be flat, rectangular, trapezoidal or prismatic, or any other appropriate elongate shape. Advantageously, the first and/or second insert is cylindrical or at least generally cylindrical, having an aspect ratio of at least 1:5 (diameter:length). However, the insert may also be a deformed wire, such as a generally sinusoidal shaped wire/square-wave shaped wire. The first insert may have a length less than the length of the first receiving portion and the second insert may also have a length less than the length of the second receiving portion. Accordingly, there may be provided one or more first inserts or second inserts provided in each of the first and second receiving portions respectively. Advantageously, the second insert is the same as the first insert. The second clamping means (typically the second receiving portion) may be positioned internal of the first clamping means (typically the first receiving portion). Alternatively, the first and second inserts may have a length greater than the length of the first and second receiving portions respectively, where multiply receiving portions are joined together.

Alternatively, the first and second inserts may have lengths equal to the length of the first and second receiving portions respectively. It is desirable that the first insert and/or the second insert are provided along substantially all of the length of the first and second receiving portion respectively so as to avoid “gaps” along the length of the receiving portion. This is desirable because it typically provides a good seal, minimising the escape of atmosphere from within the closed system.

The cover may be at least partially translucent or at least partially transparent. The cover may comprise a flexible material. The cover may comprise a polymeric material. This has the advantage of providing a lightweight, durable, relatively cheap component compatible with the closed system configuration described above. By being flexible, the cover may be folded or rolled up before being integrated into the greenhouse. This has the advantage of providing a relatively compact component which can be easily transported, where the cover can be unrolled and assembled with the greenhouse. The cover may be wholly sheet-shaped and absent of apertures, or may have a series of apertures. Apertures in the cover may be configured to receive at least part of an upper fixing assembly adapted to seal the growing chamber defined by the cover in combination with the rail and the liner as well as co-operate external structures configured to hold the greenhouse in position. In particular, such an arrangement may allow for the cover to be supported in a suspension arrangement, by means of said upper fixing assembly.

The upper fixing assembly often comprises a fixing suitable for attaching to a suspension system and a sealing member, adapted to cooperate with an aperture in the cover of the greenhouse so as to form a closed system. The sealing system may be disc-shaped and is typically configured to be larger than a corresponding aperture of the cover or alternatively, the sealing system may be configured for insertion into the corresponding aperture in the cover. Often the sealing system and the fixing are joined together by means of a connector, typically a rope or wire. In addition, the sealing system may be made from a polymeric material and is typically made from the same material as the cover. The sealing system may be fastened to the cover by means of an adhesive, clips and/or by heat sealing the material of the cover and the material of the sealing system together. This is advantageous as it permits the cover to be connected to the suspension system at several places in order to maintain the shape of the cover. Most commonly, ultrasonic welding is used to form the closed system.

The greenhouse may further comprise a truss. The truss may comprise: a first anchoring member positioned at a first end of the greenhouse; a second anchoring member at a second end of the greenhouse; and a connection member suspended between the first and second anchoring members; wherein, in use, the connection member cooperates with the cover in order to hold the cover in position. Although the term “truss” may include a structure comprising a plurality of struts, it may equally be a single structural component such as a “telephone-pole” arrangement and generally is intended to encompass an accompanying or integral support structure adapted to maintain the greenhouse in an erect or deployed format. A truss is typically configured to translate a force or bending moment. A truss may do this without noticeable deformation, creep or fatigue. The truss may be external of the closed system. The connection member may be a line, wire, cable or similar element capable of being tensioned. The suspension arrangement has the advantage of providing structure to a greenhouse formed from typically flexible materials whilst minimising the amount of substantive construction required to erect a complete greenhouse structure, especially useful in remote environments. Moreover, such an arrangement is suitable for large-scale applications and the exact size of the greenhouse can be precisely tailored based on space available in the target environment. It may be the case that additional struts or pylons are provided, especially in situations wherein the truss is particularly long length, to ensure the truss supports the cover across the full length of the greenhouse. In particular, said struts or pylons may be positioned on one or both sides of the greenhouse and are particularly advantageous with suspension arrangements wherein a wire is suspended between the two anchoring points at either end of the greenhouse.

Typically the connection member is a line, often comprising a material suitable for use in tension. This is advantageous as the height of the greenhouse can be adjusted by changing the tension of the line or wire. The cover may comprise one or more attachment means for cooperation with the fixing of the upper fixing assembly.

There may also be a base sheet positioned external of the liner. The base sheet may be a ground cover to protect the liner from any damage or abrasive from contact with the ground. The base sheet may be a ridged and/or reinforcement material. The base may be planar or trough shaped, so as to conform to a desired geometry. The base may be shaped so as to create channels in the fluid bed when in used.

The greenhouse may further comprise a screen. The screen has the function of providing shade to the closed system. This is advantageous because it allows control of the light incident upon the cover and the growing chamber. This in turn provides control over the temperature within the chamber and the amount of photosynthesis taking place. The screen may be foldable or configured to have a telescopic arrangement so as to change its area depending upon the amount of shading required. The screen may be at least partially absorbent or reflective. The screen may be movable between at least a first position and a second position so as to vary the amount of light incident upon the cover. The screen may be controlled externally, or by means of a closed circuit system in which the screen is moved depending on a sensor output. The screen may be moved so as to maintain the light conditions in the closed system at a certain level, acting in response to external environmental light level fluctuations and/or conditions within the growing chamber.

The greenhouse may further comprise at least one passive buffering system. The passive buffering system may be selected from: a thermal buffer, a desiccant, a CO2 buffer or a combination thereof. The term “passive buffering” is intended to mean that it does not require power, typically electrical power, in order to moderate the parameter in question. Buffering occurs automatically. Such systems have a maximum buffering capacity and in order to provide the desired level of control, i.e. without being overwhelmed, they must be provided in sufficient quantities (or at least have sufficient capacity) and be able buffer at an appropriate rate. For instance, the rate of absorption into and out of a carbonate solution should ideally be sufficient to meet the demand of plants growing within growing chamber. The greenhouse may further comprise an air conditioning means.

The greenhouse may further comprise a second sub-assembly, wherein the first and second sub-assemblies, the cover and the liner cooperate with each other so as to form a closed system. Specifically, one end of the cover may be clamped between the first clamping means of the first sub-assembly, and another end of the cover may be clamped between the first clamping means of the second sub-assembly. Equally, one end of the liner may be clamped by the second clamping means of the first sub-assembly, and another end of the liner may be clamped by the second clamping means of the second sub-assembly. This provides an arrangement in which there is a bridging portion between the first and second clamping means of the rail on both the first and second sub-assembly. Such bridging portions may be functionalised for a variety of purposes. For instance, the bridging portions may each independently comprise features adapted to monitoring and or maintain conditions within in the closed system.

The bridging portion may be adapted to promote condensation thereon. This has the advantage of permitting active removal of humidity from the atmosphere within the closed environment. The bridging portion may be cooled by means of a cooling fluid, head sink, or other appropriate means, to promote surface condensation. This is advantageous as by controlling the cooling of the bridging portion, it is possible to selectively promote precipitation and hence reduce the humidity within the atmosphere within the closed system. The bridging portion may also be surface modified to promote condensation. The bridging portion may comprise a hydrophilic surface for precipitation collection control. Accordingly, this facilitates control of water throughout the closed system between liquid or gaseous states.

The first and second sub-assemblies may be similar to or identical to each other. The first and second sub-assemblies may be arranged in use so that they are mirror images of each other.

The first sub-assemblies and second sub-assemblies may each independently further comprise an inner bar disposed between the first and the second clamping means, the inner bar comprising one or more functional features mounted thereon. The term “inner bar” as used herein is intended to encompass a general track or mounting element to which functional features can be readily mounted, either moveably or statically. In addition, the inner bar may further comprise one or more carriages, moveable along the inner bar, to which the one or more functional features may be affixed. The inner bar may comprise one or more functional features selected from the group consisting of: sensors, sprinklers, cameras, collection means, heat exchangers, lights or combinations thereof. The sensors may be configured to monitor the greenhouse environment, in particular; temperature, humidity and the concentration of gases in the environment (such as CO2 and oxygen). Where the greenhouse is for macrophyte growth (that is to say adapted for containing a fluid bed), the system may comprise sensors to monitor the conductivity, nutrient concentrations, pH and other variables in relation to the water within the fluid bed. Such sensors may also be mounted as described above. The sensors may communicate with a control system, and/or communicate with adjacent systems of the greenhouse, such as a thermal syphon or valves, to control the environmental conditions within the greenhouse. The inner bar is typically elongate and may be provided as a plurality of connectable linkages.

The greenhouse sub-assembly may further comprise at least one supporting element adapted to cooperate with the rail. The term “supporting element” is intended to refer to a strut or leg to which the rail is mounted so that, in use, the supporting element can be embedded in or fixed to the ground and provide a raised platform for the rail. Typically, the supporting element and the liner together create the walls of the greenhouse wherein the supporting element provides the reinforcement—especially important when the greenhouse is for macrophyte growth.

The greenhouse sub-assembly may comprise at least two supporting elements adapted to cooperate with the rail. Having two supporting elements can provide increased structurally reliability compared to just one supporting element. The two supporting elements may provide a greenhouse with an outer wall (directly adjacent the external environment) and an inner wall (directly adjacent the liner). It is often the case that a cross-support is provided connecting the first and second supporting elements together. The cross-support has the advantage of minimising shear deformation of the sub-assembly, thereby reinforcing the rail. The cross-support may be arranged so that it is generally perpendicular to at least one or both of the supporting elements. There may be provided two cross-supports. Two cross-supports may be arranged in a cross-shape, with both being diagonal to at least one of the supporting elements. Alternatively a foam could be used to reinforce the sub-assembly. This is a useful reinforcing material in the present invention as it is cheap, deployable, will resist force in a variety of directions and permits the easy incorporation of conduits therethough facilitating external communication with the bridging portion and any functional features connected thereto. The first and/or second supporting elements may comprise an anchor configured to stabilise the rail relative to the ground.

The sub-assembly may be fabricated from a single piece of material. The single piece of material may be sheet material, typically metal. It is often the case that multiple sub-assemblies can be combined together to form a longer single sub-assembly depending on the size of the greenhouse required. Individual sub-assemblies may be welded, glued, crimped, fastened, and/or moulded together into a longer sub-assembly. A single piece of material has the advantage of simplicity, a lower chance for flaws, fractures or openings which could provide leaks to the closed system. A single piece of material also has the advantage of improved strength and structural capability compared to separate pieces fixed to each other, as it benefits from homogeneity and an absence of significant points of weakness in the component. However, in those scenarios where terrain or equipment constrain the construction of a single sub-assembly, several shorter sub-assemblies may be joined together. Several sub-assemblies may be connected together using bolts, spot welding or other fastening techniques familiar to the person skilled in the art.

In an alternative embodiment of the invention, the rail of the first sub-assembly may, instead of being mounted on a supporting element, be affixed to the ground. It may be the case that a trough is formed in the ground and the sides of said trough provide the structural support for the sides of the growing chamber (formed by the liner and the cover). Accordingly, it is not necessary for the rail or the supporting element itself to provide support to the sides of the growing chamber. The sides of the trough are usually at an angle around 25° to 60°, more typically 40° to 50° and most typically about 45° with respect to the base so as to not place excessive stress on the walls of the growing chamber (typically the liner).

This configuration is often employed where the greenhouse is for macrophyte growth. This requires a water bed to be provided so that plants may grow on the surface of said water. In such situations, it is often the case that the rails will be anchored to the ground and the sides of the trough provide support to the sides of the growing chamber. This can be achieved in a number of ways depending on the terrain upon which the greenhouse is constructed as would be familiar to the skilled person. However, a common method of anchoring the one or more rails in place is to sink pillars into the ground, either side of the trough, to which the rail may be attached. Concrete or other setting materials may be used to hold the pillars in position. There is no particular restriction on the size of the trough with which the invention is compatible but it is typically the case that the trough or troughs have a depth of less than 2 metres, usually have a width of less than 20 metres and often have a length greater than 50 metres (usually greater than 100 metres).

In such embodiments, the trough is usually formed in the shape of a raceway allowing water to be circulated around in a continuous loop or circuit about a one or more dividers, typically there is one central divide. One or more rails may be provided on the side of the trough. One or more rails may also be provided on the central divide, where a raceway is employed, in order to facilitate enclosure of a generally toroidal growing chamber.

As with other embodiments of the invention, the rail may comprise clamping means located along the length of the rail. This could be in the form of a plurality of individual clamping means spaced along the rail, typically evenly distributed along the length of the rail. Alternatively, said clamping means may consist of a single elongate clamping means running the entire length of the rail. Again, as with other embodiments of the invention, the rail and the clamping means may be integrally related with one another or the clamping means may be attached to rail. For example, the rail itself may be C-shaped and adapted to receive a fastening element such that the cover and/or liner may be sandwiched therebetween. There is no particular restriction as to how the rail and the clamping means may be attached to one another but this is usually achieved using screw fittings. Furthermore, as with other embodiments of the invention, whilst each side of the greenhouse typically only comprises one rail, said rail may be comprised of a series of connected or interlocking segments of rail which, together, make up the rail running the entire length of the greenhouse. That said, two or more rails may be provided in parallel on a single side of the greenhouse, for example so as to carry two sets of clamping means, one which may be adapted for the cover and another adapted for the liner. In such situations, the two rails will be in communication with one another so as to ensure a closed system, for example by means of a connecting element which may further permit equipment to be mounted thereon between the two rails.

It may be the case that a gutter for collecting rain water is attached to the ground and one or more rails are mounted to said gutter. The gutter may also be attached to the pillars. The gutter may also be configured to slope towards a collections apparatus to aid collection of rain water. Alternatively, the rail itself may be the gutter to which the clamping means may be directly attached. Positioning a gutter alongside the greenhouse is a useful way of collecting rain water as rain falling upon the roof of the greenhouse will flow down the roof and into the gutter. Often, a gutter will be placed either side of the roof to catch rain flowing off both sides of the roof. This water can be stored in a water storage system which may be in communication with the growing chamber, permitting the captured water to be introduced into the system as necessary.

It is often the case that the position of the rail with respect to the pillar or gutter can be varied so as to loosen or tighten the tension on the cover and/or liner. For example, the pillar or gutter may have several attachments points to which the rail may be connected, each of which may be spaced further or closer to the middle of the trough. There is no particular restriction on the means used to attach the rail to the pillar (or gutter) but it is often the case that the rail is attached using screw fittings. Similarly, in addition to or as an alternative to the above, the position of the clamping means with respect to the rail may also be varied so as to loosen or tighten the tension on the cover and/or liner.

As with the other embodiments described herein, whilst it is commonly the case that each of the liner and the cover are provided as single pieces of material, it may be the case that each of the liner and the cover are made up of a plurality of liner components and cover components respectively. These components can be joined together in order to make a complete liner or cover and then attached to the clamping means in order to create the closed system. As the length of the greenhouses of the invention can be in excess of 100 metres in length, sourcing single sheets of cover or liner material can be difficult.

Moreover, in the event that a portion of the cover is damaged, having a segmented cover and/or liner allows replacement cover components or liner components to be introduced without the need of replacing an entirely liner or cover and avoiding the need for patching damaged areas (which can often provide unsatisfactory results). The mechanism by which the liner components and/or cover components are joined together is not particularly limited. For example, this could be by means of heat sealing, crimping, stapling, clamping or a combinations thereof. It may be the case that adjacent liner and/or cover components at connected using the same clamping means used to create the closed system. A snap-fit or interference-fit connecter may be used to clamp together two adjacent liner or cover components. The clamping means is typically an interference-fit connector, typically composed of a receiving portion, usually C-shaped, into which a fastening means can be inserted such that the cover and/or liner inserted therein is trapped securely between the fastening means and the receiving portion. Said receiving portion is typically elongate and usually runs at least the entire length of the greenhouse. The receiving section is usually continuous along the length of the greenhouse, though may be formed from a plurality of communicating receiving sections or provided as a series of interconnected or adjoining elements. Often the fastening means will comprise one or more generally sinusoidal wires. Often, the wire will have a square-wave configuration. Although it is often the case that one clamping means is used to securely clamp both the cover and the liner, it may be the case that a first clamping means is used for the cover and a second clamping means is used for the liner.

Whilst some embodiments of the invention employ a suspension system in order to maintain the shape of the growing chamber (especially the roof and the sides), alternative solutions to this approach are also envisaged. For example, a supporting frame may be provided over or under which the cover can be stretched, though this is usually under the cover. Said supporting frame may comprise a plurality of rigid members spanning the trough or raceway (or a channel thereof) so as to maintain the shape of the cover. There is no particular restriction on the shape of the frame but it typically comprises one or more arches. There is no particular restriction on the choice of material from which the supporting frame is fabricated though it is typically made from a light weight, robust, water resistant material such as metal (e.g. steel or aluminium), wood, plastics or a combination thereof. Said supporting frame may also comprise a coating to enhance the properties of said frame, for instance by enhancing water resistance. The frame is typically composed of lightweight tubes often made from metal, such as steel or aluminium. Often, the steel is stainless steel so as to prevent rusting in a moisture rich environment, though galvanised, electroplated or painted steels are also envisaged. The frame may also communicate with the pillars or gutters described above so that each component of the system is commonly anchored to the ground and can be assembly with relative ease. Further, the frame may also be ribbed or otherwise textured so as to grip the cover.

As explained above, the greenhouse may also comprise a screen, which is often static but which may be of a telescoping or expandable construction. Typically, the screen is mounted external of the cover and is usually moveable along the length and width of the greenhouse, most commonly along the length in order to provide shade. The screen may be held in place by the same clamping means used to hold the cover and or liner in position. Alternatively, a separate clamping means may be provided for the screen.

Furthermore, whilst the frame may be used to predominantly provide structure to the greenhouse, as with the other embodiments of the invention, the pressure within the growing chamber can also be varied so as to control the shape of the greenhouse and/or change the resilience of the external surface to impact (as well as to modify the suitability of the internal growing environment). This can be particularly advantageous in windy conditions.

According to a second aspect of the invention, there is provided a greenhouse sub-assembly, the sub-assembly comprising: a rail, the rail comprising; a first and a second clamping means (typically a first and second receiving portion each adapted to receive a first and a second insert respectively), and a bridging portion disposed between the first and second clamping means. As mentioned above, such a bridging portion may comprise one or more functional features, as described with respect to the first aspect of the invention.

The first and second receiving portions and the first and second inserts may cooperate respectively by means of snap-fit connections. This has advantages as described above in relation to the first object of the invention. Alternatively, a vice-style sealing arrangement could be employed using flat or L-shaped rails and a plurality of bolts.

The first and/or second rail may comprise a recess configured for precipitation collection.

The recess may be configured to collect precipitation from the bridge portion. In some embodiments the recess in within the growing chamber. However, it may also be the case that a recess may be deployed on the external portion of the rail so as to collect precipitation from the external environment. Alternatively, a combination of external and internal condensation recess may be provided.

The bridging portion may comprise an inner bar as described above with respect to the first aspect of the invention.

The sub-assembly may be fabricated from a single piece of material. The single piece of material may be sheet material, typically metal. Alternatively, the sub-assembly may comprise separate pieces of material which are fixedly attached to each other. Such pieces of material may be welded, glued, crimped, fastened, and/or moulded together. A single piece of material has the advantage of simplicity, a lower chance for flaws, fractures or openings which could provide leaks to the closed system. A single piece of material also has the advantage of improved strength and structural capability compared to separate pieces fixed to each other, as it benefits from homogeneity and an absence of significant points of weakness in the component. As a skilled person will appreciate, any form of strong, non-brittle material is appropriate for manufacturing the components of the rail assembly. Moreover, given the moisture present in the growing environment in use, it is preferred that the materials from which the greenhouse sub assembly is manufactured are resistant to degradation or rusting. This could be achieved using protective coatings on exposed portions of the sub-assembly and/or by selecting composite or alloyed materials inherently resistant to degradation or rusting. Ideally, the chosen material for the rail will be rollable i.e. it can be physically formed from a roll of material by a machine into the desired elongate orientation. Often, the greenhouse sub-assembly will be fabricated from metal such as steel, typically having a carbon content between 0.04 wt. % to 0.6 wt. %, preferably 0.3 wt. % to 0.6 wt. %, or may comprise stainless steel, typically having a minimum chromium content of 11.5 wt. %. Alternatively, the bridging portion may be fabricated from aluminium so as to minimise corrosion given that this portion of the subassembly is exposed to the atmosphere of the growing chamber. Protective coating examples include a polymer coating, varnish, sprayed ceramic, paint, or other inert coating. Such a coating may prevent access of water, corrosive substances, or abrasive substances from reaching the underlying material of the rail. Protective layer examples include a layer of the material which has been hardened, heat treated, exposed to radiation, shot peened, or exposed to another suitable treatment.

The greenhouse sub-assembly may further comprise a supporting element adapted to cooperate with the rail. The supporting element may provide a wall to the closed system. The supporting element may be configured to be fixed to the ground. The greenhouse sub-assembly may comprise at least two supporting elements adapted to cooperate with the rail. The two supporting elements may be more structurally reliable than one supporting element. The two supporting elements may provide an outer wall and an inner wall to the greenhouse. The inner wall may be comprised in the closed system, and the outer wall may providing an outer barrier to protect the inner wall from abrasive/corrosive/damaging factors. The rail may comprise a cross-support connecting the first and second supporting elements. The cross-support has the advantage of preventing shear deformation of the rail when subjected to forces in use. The cross-support may act to reinforce the rail. The cross-support may be arranged so that it is normal to at least one of the supporting elements, or substantially normal to at least one of the supporting elements. The cross-support may be arranged so that it is a diagonal to at least one supporting element. There may be provided two cross-supports. Two cross-supports may be arranged in a cross-shape, with both being diagonal to at least one supporting element. The first and/or second supporting elements may comprise an anchor configured to stabilise the rail relative to the ground.

Usually, the greenhouse is for cultivating macrophytes. A macrophyte is a plant which grows on water, typically on the surface of water so as to be able to photosynthesise efficiently. Macrophytes are distinct from microphytes, the latter being small, unicellular plants such as algae. A typical construction adopted to grow macrophytes involves a fluid bed, typically involving a plurality of channels about which a fluid (typically water) is continually circulated. The fluid may be salt water or fresh water and is typically in communication with a thermal syphon and often a filter. Alternatively, the water may be in communication with a water tank. Reference to a “fluid bed” as used herein is intended to describe a container for holding water typically at the base of the greenhouse. The container is usually shaped to ensure a large surface area of water is available on which crops can be grown. One or more channels are typically provided to provide a circulating path of the water and macrophytes growing on the surface thereof. In such arrangements, it may be desirable for the fluid bed to function as thermal buffer and in a typical embodiment the atmosphere may be bubbled or passed through the fluid on entry to or exit from a growing chamber so as to promote rapid heat exchange between the two fluids and provide aeration to the water. Circulation means are also provided to ensure a continuous movement of water around the fluid bed. The materials from which the cover and the liner are made from in this scenario are typically water resistant so as to prevent permeation by water, especially through the liner forming the base of the greenhouse upon which the water is provided in use.

There is provided in a further aspect of the invention, the use of the greenhouse in accordance with the first aspect of the invention for growing macrophytes. Whilst the subassemblies used in the present invention comprise a rail, it is possible that alternatives to a rail may be employed. Accordingly, in a further aspects of the invention, there is provided a greenhouse according to the first aspect of the invention, wherein the rail has been replaced with one or more means of holding the cover and/or liner in position. Typically, these include anchoring, internal and/or external frames, magnets, sinking the ends of the liner and/or cover into the ground or a combination thereof.

The ends of the liner and/or cover may be anchored directly to the ground rather than being connected to a rail. Said ends could be attached directly to pillars embedded in the earth so as to hold the edges of the growing chamber in position. Similarly, the ends of the liner and/or cover could be equipped with a magnet which in turn communicates with a corresponding magnet anchored to the ground. Alternatively, the ends of the liner and/or cover could be buried within the ground or within some other suitable media, such as aggregate, concrete or sand.

Alternatively, instead of using a rail, the ends of the cover and/or liner could be attached to a frame supporting the greenhouse (position either internal and/or external of the growing chamber) wherein said frame is itself anchored to the ground.

The invention will now be described with respect to the accompanying figures and drawings.

### BRIEF DESCRIPTION OF THE DRAWINGS

FIG. 1 is a schematic showing an expanded cross-sectional view of the greenhouse of the invention.

FIG. 2 is a schematic showing an expanded cross-sectional view of part of the greenhouse of FIG. 1.

FIG. 3 is a schematic showing an enlarged expanded cross-sectional view of the connecting part of the greenhouse of FIG. 1.

FIG. 4 is a schematic showing the rail of the greenhouse of FIG. 1.

FIGS. 5 to 16 are schematics showing alternative embodiments of a rail of the greenhouse.

FIG. 17 is a schematic showing a connection between a cover and liner of the greenhouse.

FIG. 18 is a schematic showing a screen arrangement of the greenhouse.

FIG. 19 is a schematic showing a truss support of the greenhouse.

FIG. 20 shows one embodiment of the subassembly of the invention comprising a single support element.

FIG. 21 shows a cross-sectional view of the greenhouse of the invention.

FIG. 22 shows a perspective view of a truss used in conjunction with the greenhouse of the invention.

FIG. 23 shows a cross-section through a sub-assembly of the invention.

FIG. 24 shows a side view of a truss used in conjunction with the greenhouse of the invention.

FIG. 25 shows a cut away of a greenhouse of the invention.

FIG. 26 shows a perspective view and a top down view of one embodiment of the invention.

FIG. 27 shows a top down cross section of one embodiment of the invention.

FIG. 28 shows a side on cross section of one embodiment of the invention.

FIG. 29 shows a magnified view of a cross section through a portion of the invention.

FIG. 30 shows a side on cross section through a component of a gutter.

FIGS. 31a and 31b shows a cross section through clamping means used in the invention.

FIG. 32 shows a fastener compatible with the clamping means of the invention.

### SPECIFIC DESCRIPTION

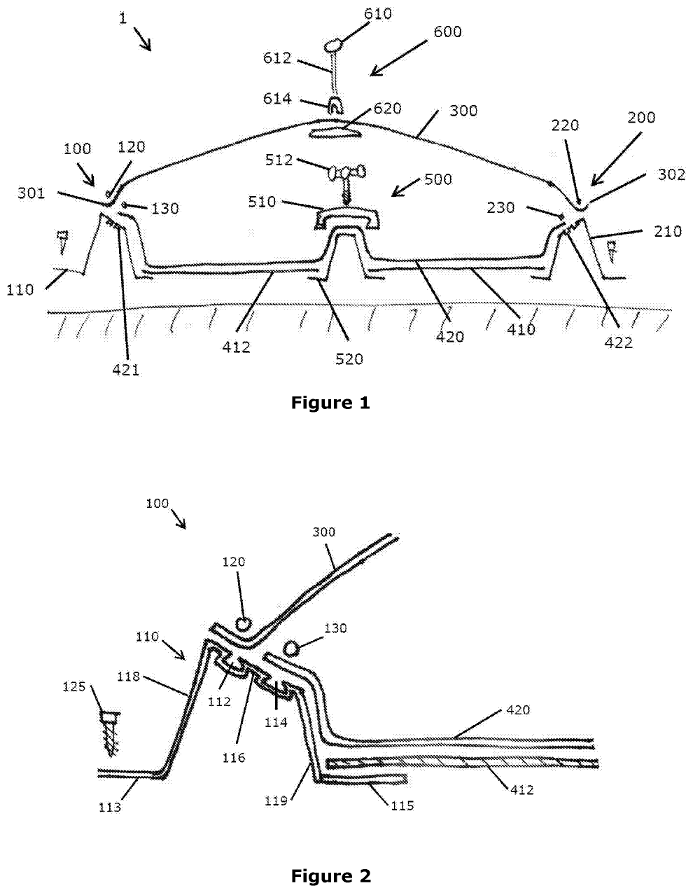

As shown in FIG. 1, there is provided a greenhouse 1. Greenhouse 1 has a first sub-assembly 100, a second sub-assembly 200, a cover 300, a liner 420, base sheets 410, 412, a lower fixing assembly 500 and an upper fixing assembly 600.

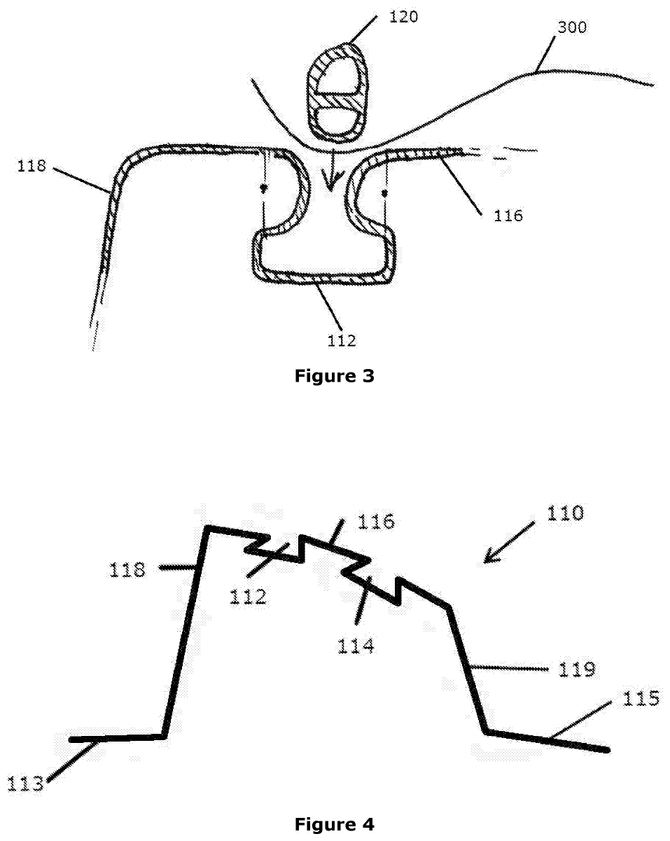

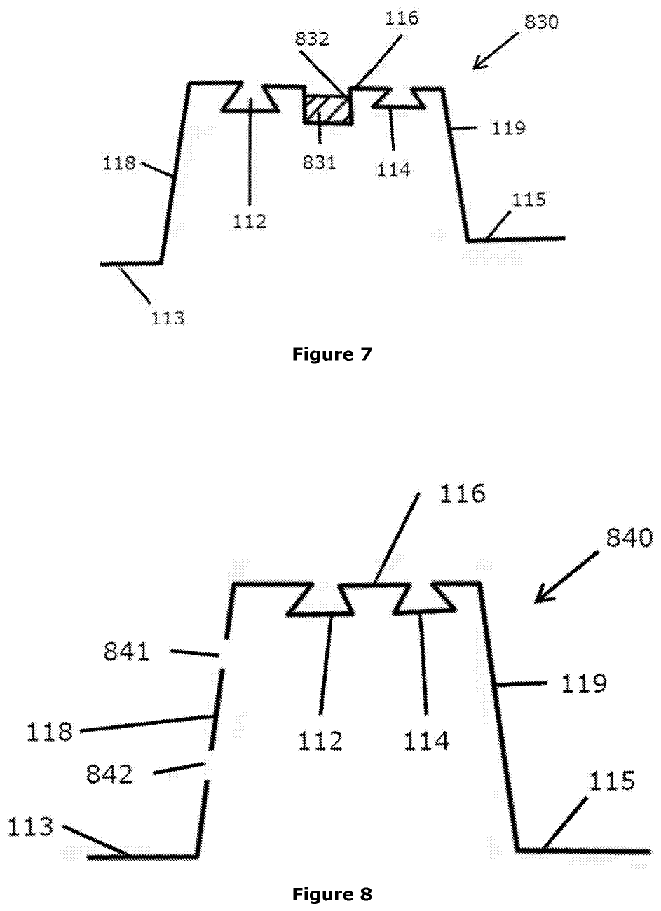

The first sub-assembly 100 comprises a rail 110, a first insert 120, and a second insert 130. The rail 110 is best seen in FIG. 2, which shows that the rail 110 comprises: an outer supporting element having an outer foot 113 and an outer arm 118; a first receiving portion 112; a bridging portion 116; a second receiving portion 114; and an inner supporting element having an inner arm 119 and an inner foot 115; which are arranged to form a substantially trapezoidal shape in cross-section, as best seen in FIG. 4. The outer arm 118 and inner arm 119 each have a length, the length of the outer arm 118 being greater than the length of the inner arm 119 so as to create a slope when in use to direct condensation towards the growing chamber. The rail 110 is elongate, a feature which is not shown in FIG. 2. In the view shown in the schematic of FIG. 2, the rail 110 is elongate into and out of the page. The rail 110 has a length in its elongate direction, and the first and second inserts 120, 130 each have a length in their elongate directions. The length of the first and second inserts 120, 130 may be equal to or substantially equal to the length of the rail 110.

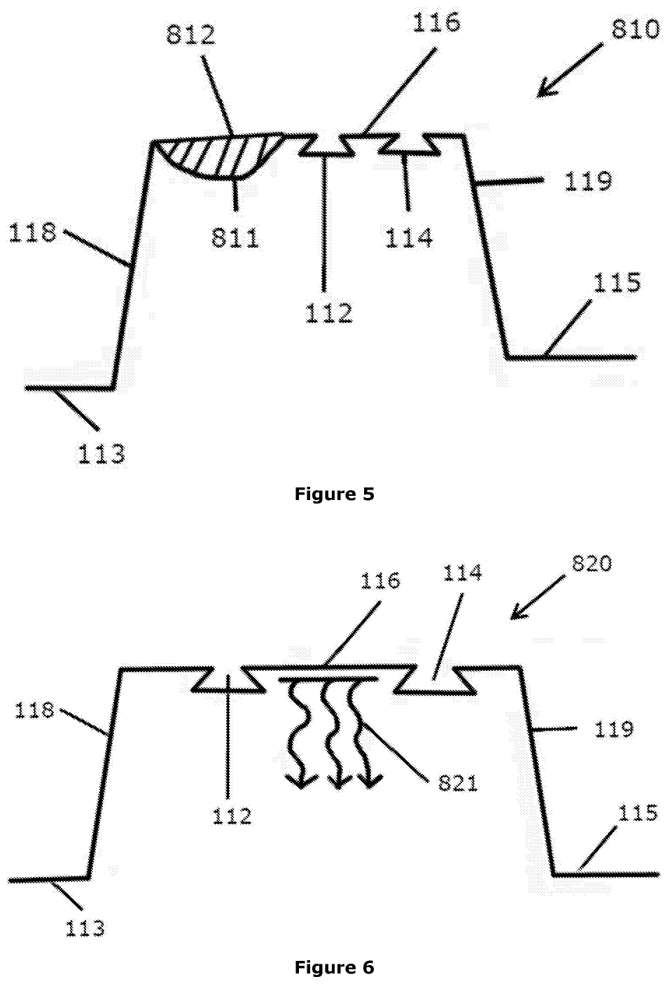

The first insert 120 is the same as the second insert 130. The first insert 120 and second insert 130 are both elongate and generally circular in cross-section. The first and second inserts are both substantially hollow, generally cylindrical, and comprise an inner divider, as shown in FIG. 3. The inner divider acts to strengthen the first and second inserts and prevent deformation of the outer cylinder of the first and second inserts. The first and second inserts 120, 130 are configured such that they can be received in the first and second receiving portions 112, 114 respectively by means of a snap-fit connection, as best seen in FIG. 3. The second sub-assembly 200 is the same as the first sub-assembly 100. In the arrangement shown in FIG. 1, the second sub-assembly 200 is arranged such that it is a mirror image of the first sub-assembly 100.

The cover 300 is a planar flexible sheet of material. The cover 300 is at least partially translucent, or at least partially transparent to allow light, in particular solar radiation, to pass therethrough. The cover may comprise a polymeric material. There is no specific limitation on choice of polymeric material, so long as it is suitable for the intended use (i.e. not biodegradable or water resorbable, that it is durable, not likely to crack in use, and can be manufactured into a sheet). An example of a suitable material is poly(ethylene).

The liner 420 is a planar sheet of material. The liner 420 comprises a material which is impermeable to fluid such as poly(ethylene) There is no specific limitation on choice of polymeric material, so long as it is suitable for the intended use (i.e. that it is impermeable, not biodegradable or water resorbable, that it is durable, not likely to crack in use, and can be manufactured into a sheet).

The two base sheets 410, 412, are planar sheets of material. The two base sheets 410, 412 comprise a material such as a polymeric sheet, a metal sheet, or any other appropriate material. The two base sheets have the function of protecting the liner from the ground. Specifically, the two base sheets are configured to protect the liner, for example from abrasive materials, rocks, or burrowing animals.

The lower fixing assembly 500 comprises a lower body 520, and one or more carriages 510 on which one or more inner bar features 512 can be affixed. The one or more carriages 510 is/are moveable along the inner bar. The one or more inner bar features 512 can be selected from the group consisting of: sensors, sprinklers, cameras, collection means, heat exchangers, lights or combinations thereof.

The upper fixing assembly 600 comprises a line 610, at least one connecting member 612, an upper attachment 614 and a lower attachment 620.

The first sub-assembly 100, the second sub-assembly 200, the cover 300, the liner 420, the two base sheets 410, 412, the lower fixing assembly 500 and the upper fixing assembly 600 are arranged in the manner shown in FIG. 1. In order to form a closed system: a first edge 301 of the cover 300 is clamped between the first receiving portion 112 of the rail 110 and the first insert 120 of the first sub-assembly 100; a first edge 421 of the liner 420 is clamped between the second receiving portion 114 and the second insert 130 of the first sub-assembly 100; a second edge 302 of the cover 300 is clamped between the first receiving portion 212 of the rail 210 and the first insert 220 of the second sub-assembly 200; and a second edge 422 of the liner 420 is clamped between the second receiving portion 214 and the second insert 230 of the second sub-assembly 200.

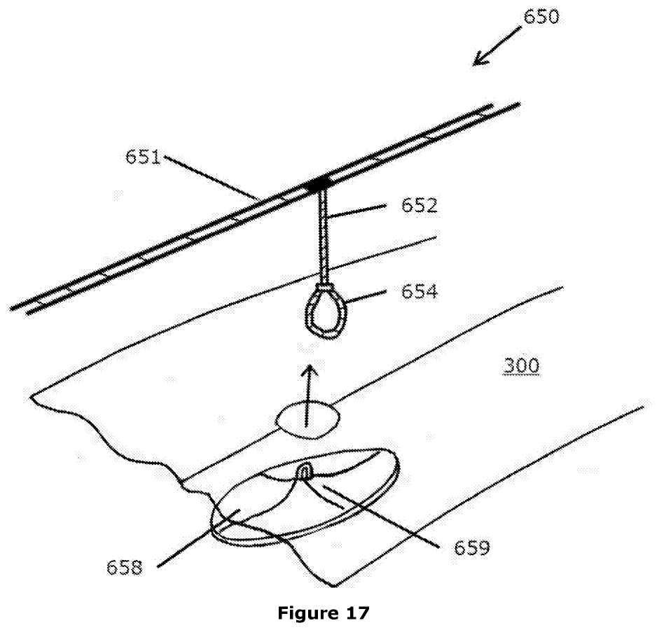

The upper fixing assembly 600 is attached to the cover 300, in particular the lower attachment 620 is attached to an inner side of the cover 300, and the upper attachment 614 is attached to an upper side of the cover 300. The upper attachment 614 is attached to the line 610 by the connecting member 612. The line 610 is connected to a support structure such as a truss, as will be described later in relation to FIG. 19. The upper fixing assembly 600 thus supports the cover 300 in suspension.

The lower fixing assembly 500 is arranged such that the upper rail 520 is external to the closed system, and the one or more carriages 510 and one or more inner bar features 512 are internal to the closed system.

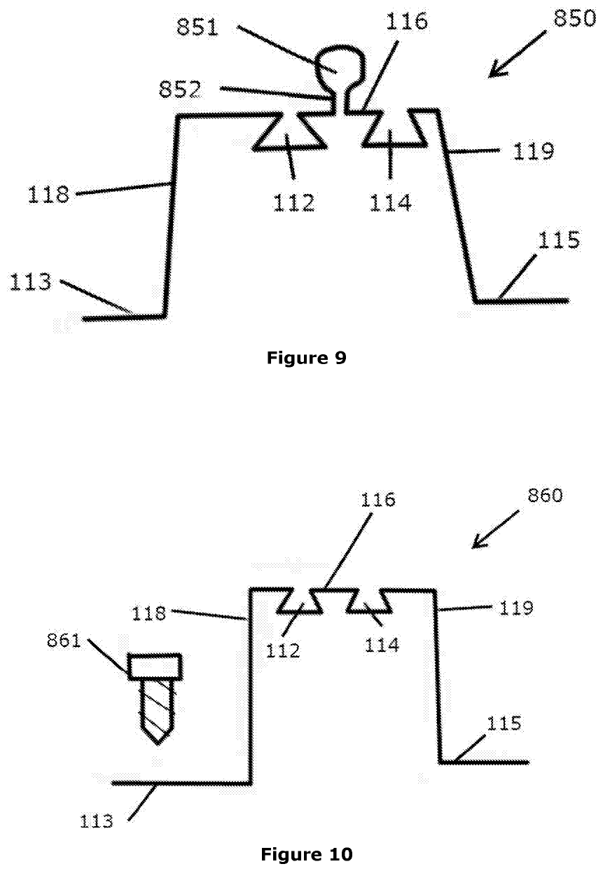

FIG. 4 is an enlarged schematic of a first embodiment rail 110 as described in relation to FIGS. 1 to 3. FIGS. 5 to 16 are schematics showing alternative embodiments of a rail of the greenhouse. Where features of the embodiments of FIGS. 5 to 16 are the same as, or correspond to, features of the first embodiment rail of FIG. 4, the same reference numerals have been used for clarity.

All rails described 510, 810, 820, 820, 840, 850, 860, 870, 880, 890, 900, 910, 920 have a first receiving portion, a second receiving portion and a supporting means such as an outer supporting element or inner supporting element. Although each embodiment of the rail in relation to FIGS. 4 to 16 have been described separately, it will be understood by the skilled person that various features of the rails described are interchangeable, and a rail may have more than one of the features described in each embodiment.

The first embodiment rail 110 differs from the other embodiments of the rail described in that the upper surface of the rail (in which the first receiving portion 112, second receiving portion 114 and bridging portion 116 are defined) is not aligned with, in particular not parallel to, the outer foot 113 and inner foot 115. In the other embodiment rails described (in relation to FIGS. 4 to 16), the upper surface of the rail (in which the first receiving portion 112, second receiving portion 114 and bridging portion 116 are defined) is aligned with, in particular parallel to, the outer foot 113 and/or inner foot 115.

FIG. 5 shows a second embodiment rail 810. The second embodiment rail 810 differs from the first embodiment rail 110 in that it comprises a recess 811 configured for the collection of precipitation 812. The recess 811 is substantially or wholly semi-circular in cross-section.

FIG. 6 shows a third embodiment rail 820. The third embodiment rail 820 differs from the first embodiment rail 110 in that the bridging portion 116 has a wider lateral dimension. The bridging portion 116 is cooled and/or surface modified to promote condensation 821.

FIG. 7 shows a fourth embodiment rail 830. The fourth embodiment rail 830 differs from the first embodiment rail 110 in that the bridging portion 116 comprises a recess 831 configured for the collection of precipitation 832. The recess 831 is square or rectangular in cross-section.

FIG. 8 shows a fifth embodiment rail 840. The fifth embodiment rail 840 differs from the first embodiment rail 110 in that the outer arm 118 defines a first aperture 841 and a second aperture 842. The first aperture 841 and second aperture 842 are configured to allow fluid, in particular air, to pass through the first and second apertures 841, 842.

FIG. 9 shows a sixth embodiment rail 850. The sixth embodiment rail 850 differs from the first embodiment rail 110 in that the bridging portion 116 comprises a bridging rail, the bridging rail having a stem 852 and a head 851. The bridging rail is configured for attachment of features such as sensors, sprinklers, cameras, collection means, heat exchangers, lights or combinations thereof.

FIG. 10 shows a seventh embodiment rail 860. The seventh embodiment rail 860 differs from the first embodiment rail 110 in that the rail 860 comprises an attachment means such as a screw 861 for anchoring the rail 860 to the surrounding environment of the rail 860.

FIG. 11 shows an eighth embodiment rail 870. The eighth embodiment rail 870 differs from the first embodiment rail 110 in that it comprises a cross-support assembly 871, 872, 873 adapted to cooperate with the rail 870. The cross-support assembly comprises a strut 871, an inner attachment means 872 and an outer attachment means 873. One or both of the inner and outer attachment means 872, 873 may be attached to the strut 871 by means of a threaded connection. The cross-support assembly acts to support the outer arm 118 and the inner arm 119 relative to each other.

FIG. 12 shows a ninth embodiment rail 880. The ninth embodiment rail 880 differs from the first embodiment rail 110 in that it comprises an anchor 811, 822. The anchor of the ninth embodiment rail 880 shown in FIG. 9 is formed of a raised part 881 of the outer support 113, and a filling material 882 such as rocks, gravel, sand, pellet weights, or any other suitable filling material. The raised part 881 of the rail 880 acts to contain the filling material 882.

FIG. 13 shows a tenth embodiment rail 890. The tenth embodiment rail 890 differs from the first embodiment rail 110 in that it comprises a first retainer screw 891 and a second retainer screw 892.

FIG. 14 shows an eleventh embodiment rail 900. The eleventh embodiment rail 900 differs from the first embodiment rail 110 in that the bridging portion 16 comprises a wire protection/retention feature 901 to receive wires 902.

FIG. 15 shows a twelfth embodiment rail 910. The twelfth embodiment rail 910 differs from the first embodiment rail 110 in that the inner arm 119 extends beyond the outer arm 118. The inner arm 119 is configured to extend into the ground, acting as an anchor to the rail.

FIG. 16 shows a thirteenth embodiment rail 920. The thirteenth embodiment rail 920 differs from the first embodiment rail 110 in that it comprises a heat exchanger or condenser 921. The heat exchanger or condenser 921 shown in FIG. 16 has a series of vanes 922, in particular six vanes.

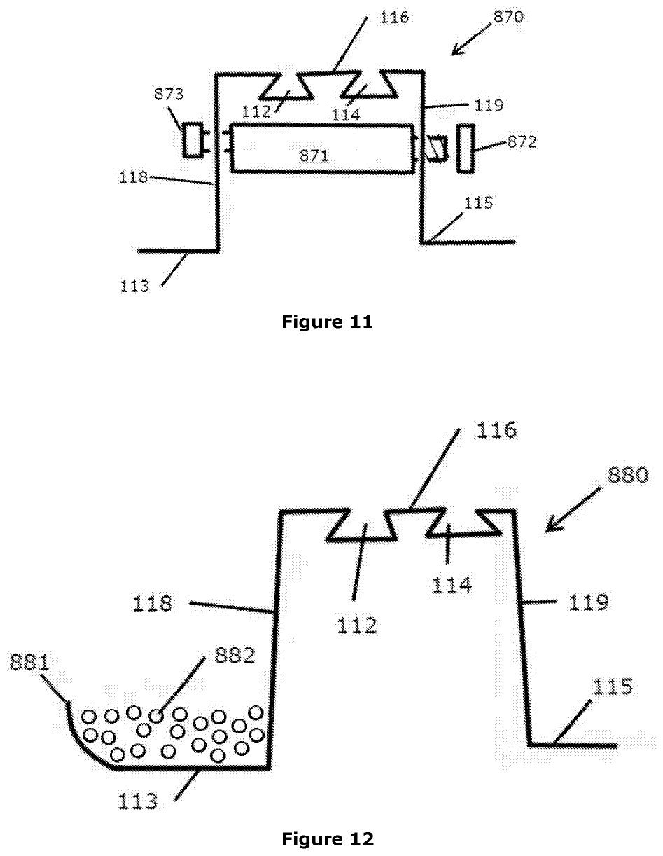

FIG. 17 shows a perspective view of part of a second embodiment upper fixing assembly 650. Similar to the upper fixing assembly 600 described previously, the second embodiment upper fixing assembly 650 shown in FIG. 17 is attached to the cover 300. The second embodiment upper fixing assembly 650 has similar components to the first embodiment upper fixing assembly 600 in that it has: a lower attachment 658 (having an equivalent function to the lower attachment 620); an upper attachment 654 (having an equivalent function to the upper attachment 614); a connecting member 612 (having an equivalent function to the connecting member 612); and a line 651 (having an equivalent function to the cline 610). The lower attachment 658 is a disc shape and has a tapered portion 659 having an attachment means such as a loop. The upper attachment 645 is a loop and may be an integral piece with the connecting member 652. The upper attachment 654 and connecting member 652 may be a rope.

The second embodiment upper fixing assembly 650 is attached to the cover 300, in particular the lower attachment 658 is attached to the upper attachment 614 through the cover 300. Particularly, the loop of the upper attachment 654 may pass through the loop of the tapered portion 659 of the lower attachment 658. The upper attachment 654 is attached to the line 610 by the connecting member 612. The line 651 is connected to a support structure such as a truss, as will be described later in relation to FIG. 19. The upper fixing assembly 600 thus supports the cover 300 in suspension.

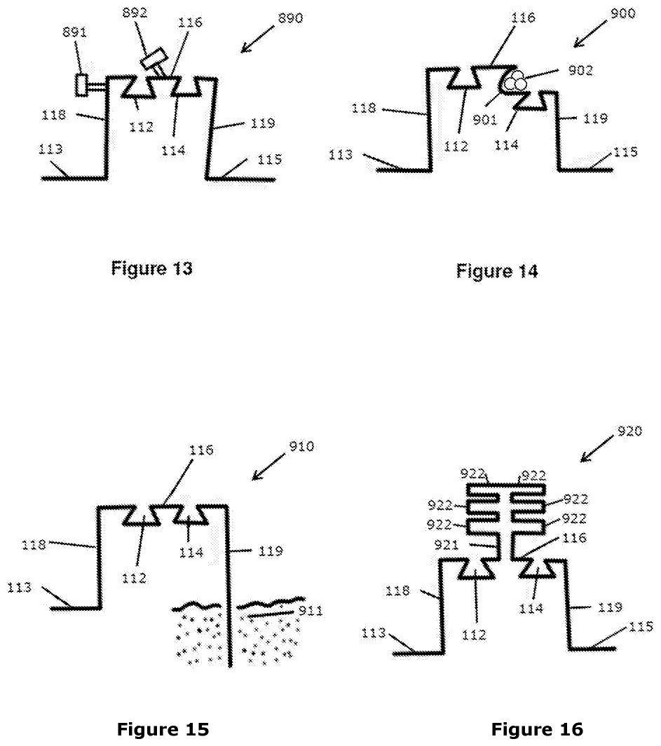

FIG. 18 shows a screen assembly 750 and truss 700 of the greenhouse.

Screen assembly 750 has a screen 752 and a plurality of screen lines 751, 752. 753, specifically three screen lines as shown in FIG. 18. The screen 752 is configured to at least partially absorb or reflect light, such that light incident on one side of the screen (particularly an upper side of the screen) has a higher energy, specifically a higher intensity than light passing out of the other side (particularly the lower side) of the screen. The screen lines 751, 752, 753 are configured to support the screen 752 relative to other components of the greenhouse.

Truss 700 is configured to be a supporting structure. Specifically, the truss 700 is configured to support lines such as the lines 610/651, 761, 762, 763 of the greenhouse in tension.

FIG. 19 shows a cross-section through part of the greenhouse, in which truss 700, screen lines 751, 752, 753, line 610/651, connecting members 612/652, and screen 300 are shown. Truss 700, as shown in FIG. 19, is triangular in cross-section and comprises a plurality of connecting struts 701. Truss 700 may have a triangular cross-section (as shown in FIG. 19) across its full length, or may have a series of section as shown in FIG. 19 connected by bars.

As will be understood by the skilled person, although various features of the greenhouse have been described in detail, these features are advantageous but not necessary to implement the invention. It will also be understood by the person skilled in the art that where more than one embodiment of a feature has been described, these embodiments are interchangeable, and advantageous features of these embodiments are interchangeable or can be used in combination for the greenhouse.

Although a greenhouse having two sub-assemblies has been described, it will be understood that a greenhouse having only one sub-assembly is possible. In a greenhouse having only one sub-assembly, the cover and the liner are attached to each other, and may be a single sheet folded over to form both the cover and the liner.

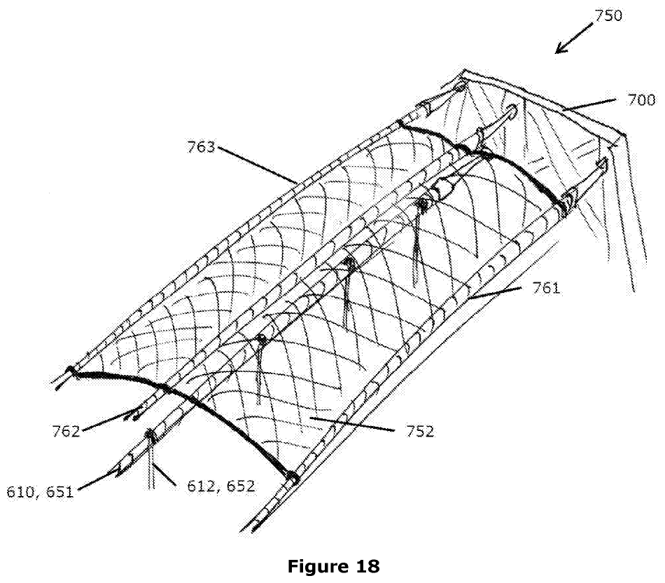

FIG. 20 shows a sub-assembly 800 in accordance with the present invention including a single concrete pylon 817 acting as a supporting element for rail 811 mounted on the top thereof. The rail 811 is bolted to the concrete pylon 817 by means of bolt 813. In an alternative embodiment, two “half-rails” 801, 802 are depicted in detail which act as clamping portions for the cover 807 and the liner 809 respectively. These can both be mounted, spaced apart, upon a supporting element such as concrete pylon 817 such that the pylon creates the bridging portion between the two half-rails 801, 802. Alternatively, a single rail 811 may be employed wherein the bridging portion between the two receiving portions is integral to the rail. The snap fit connectors 803 are provided to create a clamping action with the recesses 810 within the half rails. There is also provided an intermediate snap-fit connector 805 which, in use, is sandwiched between the boundaries of the recess 810 and the snap-fit connector 803. This ensures a good seal between the cover 807 or liner 809. The rail 811 or half rails 801, 802 can be affixed to a supporting element by a variety of means, such as nuts and bolts 815, 813.

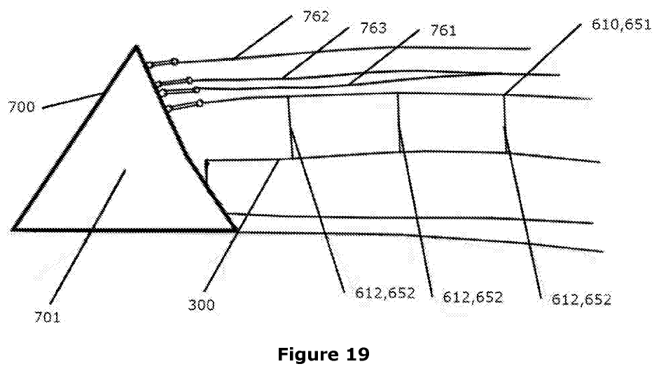

FIG. 21 shows a perspective view of the greenhouse 850 having a polymeric cover 852 and polymeric liner 854 attached to a first rail 856 at an outer and inner clamping portion respectively (not shown). A base 858 is provided against which the liner 854 abuts. The cover 852 and the liner 854 also cooperate in a similar fashion with the second rail 862. A supporting cable 864 is suspended above the cover 852 between anchoring members 866. The cover 852 communicates with the cable 864 via a plurality of connection members 868.

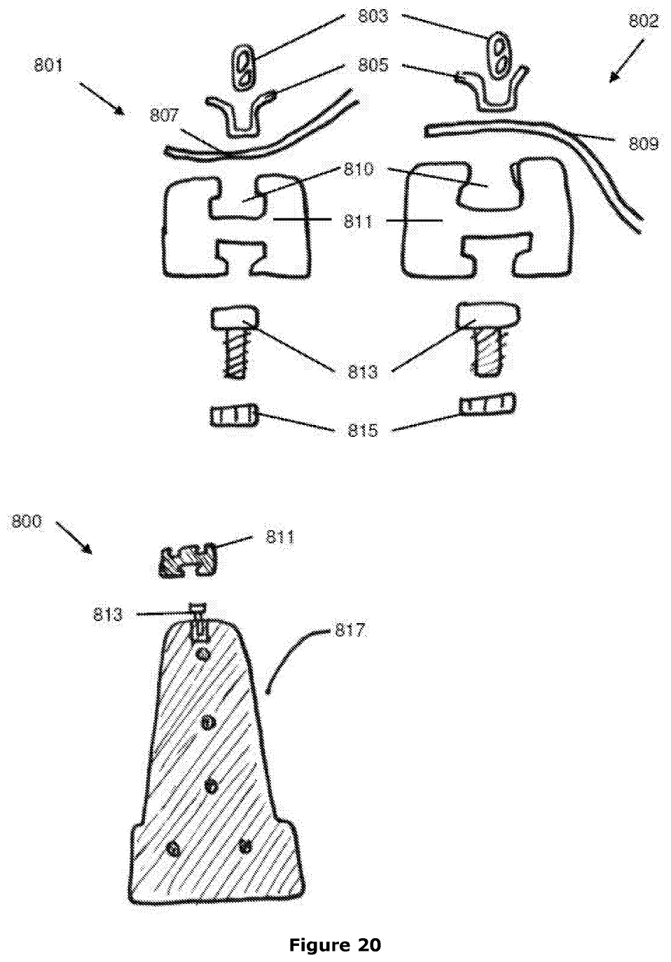

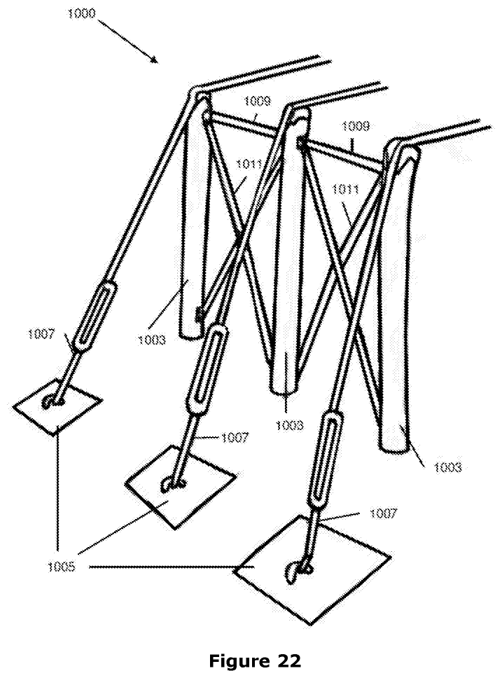

FIG. 22 shows an example of an anchoring member 1000 in more detail. Three struts 1003 are provided, connected together with lateral and diagonal cross bars 1009, 1011. Each of the three supporting cables 1007 rest upon a corresponding strut 1003 and each is attached to an anchoring plate 1005 embedded within the ground, potentially fixed in place with concrete. FIG. 24 shows this in more detail as a side on cross section. The anchor plate 1005 may be a block of concrete with an anchor point set or screwed in position to form a ring or eyelet 1015 to which the cable 1007 may be attached.

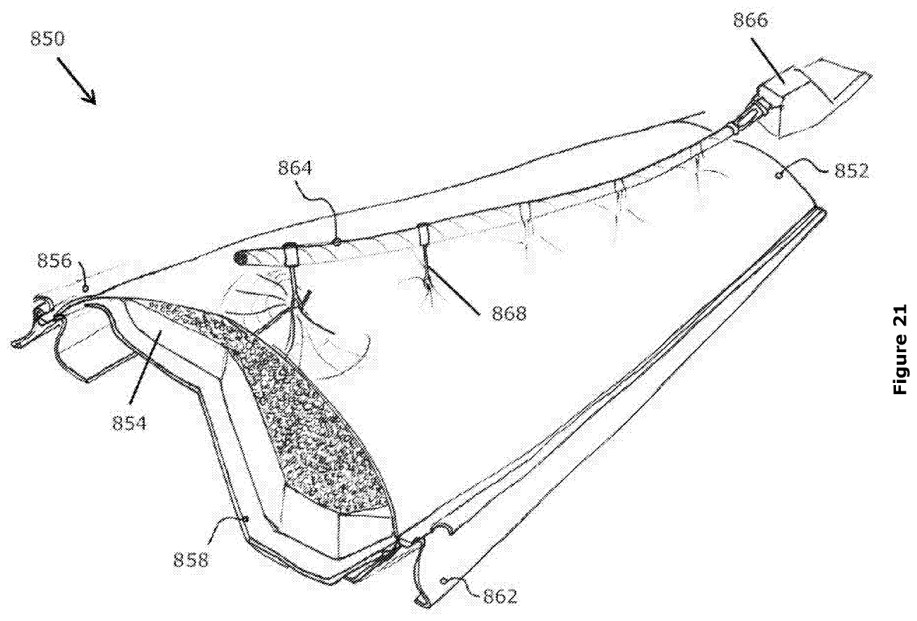

FIG. 23 shows a cross section through a rail 804 using two spaced apart “half rails” 811 which each create a clamping portion able to hold the cover 807 and liner 809 in place respectively. A nut 815 and bolt 813 are used to affix the half rails 811 to the main body of the rail 804. The cover 807 and the liner 809 may be clamped in place by inserts 803, 805 into the recesses of the half rails 811. The main body of the rail may be affixed to the ground or a base plate using fixings or adhesives 819.

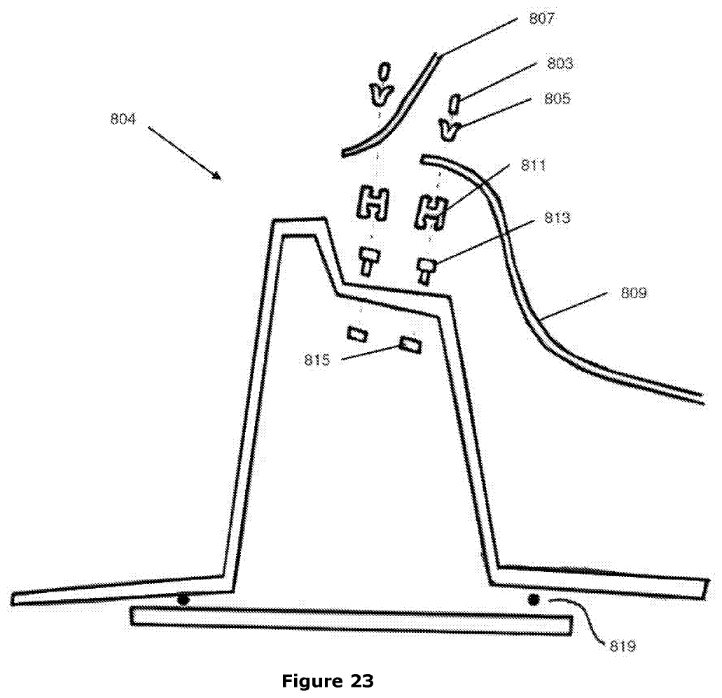

FIG. 25 shows a cutaway diagram of the greenhouse 950 of the invention. The polymeric cover 951 encloses the growing chamber in which a fluid bed 957 of water is provided in the form of water channels in which macrophytes may be cultivated. A supporting cable is provided to ensure the cover is held in position and does not unduly sag. A harvesting machine 955 is provided to extract macrophytes from the surface at intervals. The atmosphere within the growing chamber is cycled through a subterranean network of tubes 961 via a fan system 959 and the temperature, humidity and atmospheric composition is controlled using passive buffering systems 963 before being returned to the growing chamber.

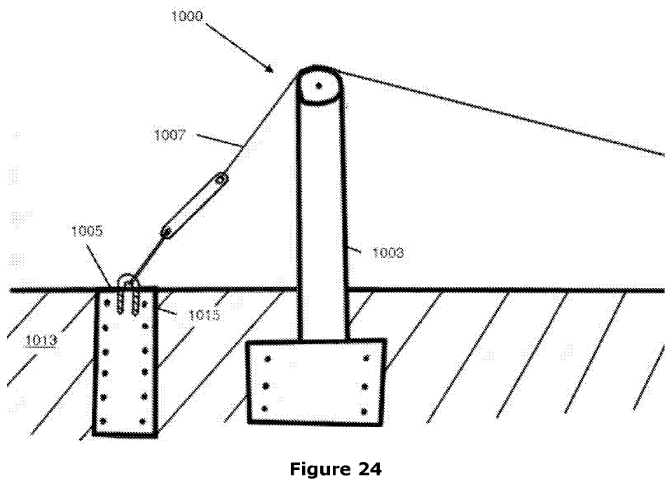

FIG. 26 shows a perspective of an alternative embodiment of the invention. The growing chamber (not shown) of the greenhouse 1001 is formed between two concave adjacent parallel plastic tunnels 1002a/1002b extending over the entire length of an earthwork raceway excavated from the ground (not shown). The roof of the tunnel comprises a plastic cover 1004 which has been stretched over a plurality of arched galvanised steel poles 1008. The cover 1004 is clamped in place using clamping means (not shown) at each of the gutters 1010a, 1010b, 1010c provided at the base and edge of the two adjacent tunnels.

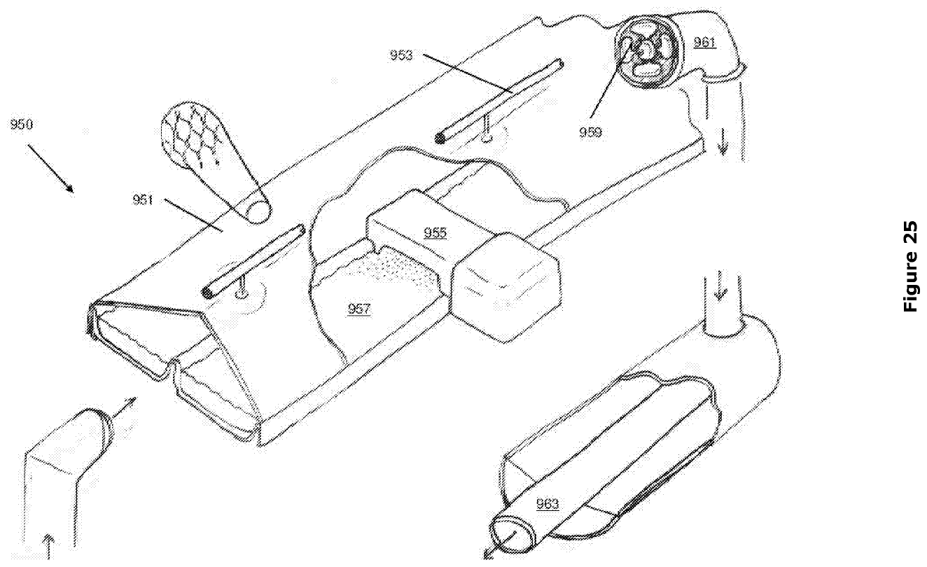

FIG. 27 shows a top down cross section through the middle of the greenhouse shown in FIG. 26. An earthwork raceway 1109 is shown which has been excavated from the ground 1111 with a central divide 1103 and a two channels 1105a/1105b connected at both ends 1106a/1106b of the raceway 1109 around which water can be circulated in use. A plurality of pillars 1112 are shown to which gutters (such as those shown in FIG. 26) or rails can be attached. The raceway 1109 typically has dimensions of approximately 200 m in length, 20 m in width and about 1.5 m in depth.

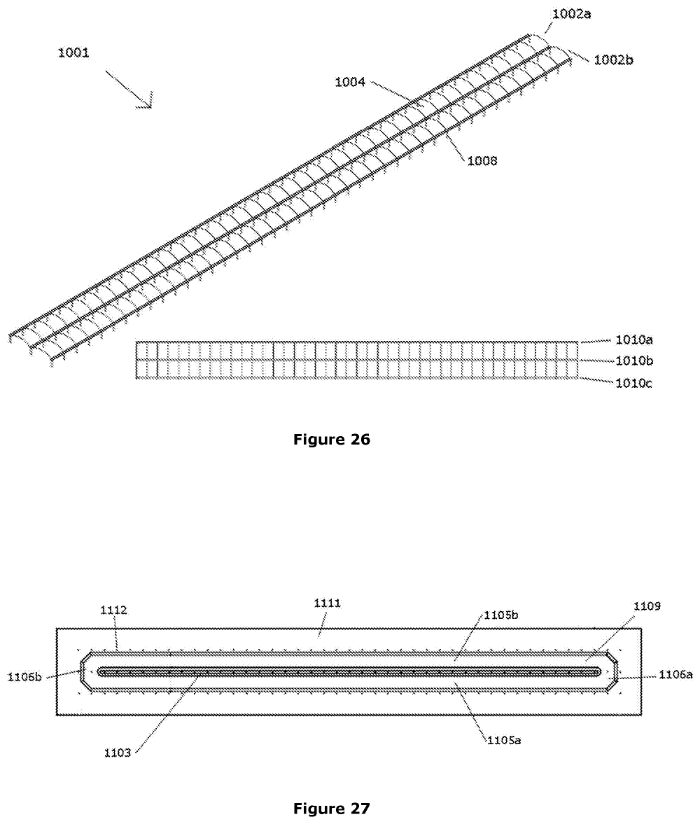

FIG. 28 shows a cross section through the greenhouse 1201 of FIG. 26. An earthwork raceway (not shown) is formed in the ground 1205 in order to form two channels 1207a/1207b connected at both ends (not shown) of the raceway 1203. A liner 1209 is provided in each channel 1207a/1207b and the liner 1209 abuts the base 1211 and each end of the liner is clamped in place using an interference-fit clip 1213 mounted on an arm 1214 of the gutters 1010a/1010b/1010c. Said gutters are positioned at the edge of each channels 1207a/1207b so as to catch any rain flowing off the greenhouse cover 1219. Arched galvanised steel rods 1220 are provided spanning each of the channels 1207a/1207b and over which the cover 1219 is stretched.

A plurality of pillars 1221a, 1221b, 1221c are provided around the perimeter of the raceway (not shown) and along the length of the central divide 1222 (three of which 1221a, 1221b and 1221c are shown in FIG. 28). The pillars 1221a, 1221b, 1221c extend down into the ground within holes 1223 in the ground 1205 and into which concrete 1225 is poured to hold the pillars in position. The gutters 1010a, 1010b and 1010c are each connected to their respective pillars 1221a/1221b/1221c by means of screws. Both the liner 1209 and the cover 1219 can be inserted into the interference-fit clips 1213 so as to form the closed system of the growing chamber 1227.

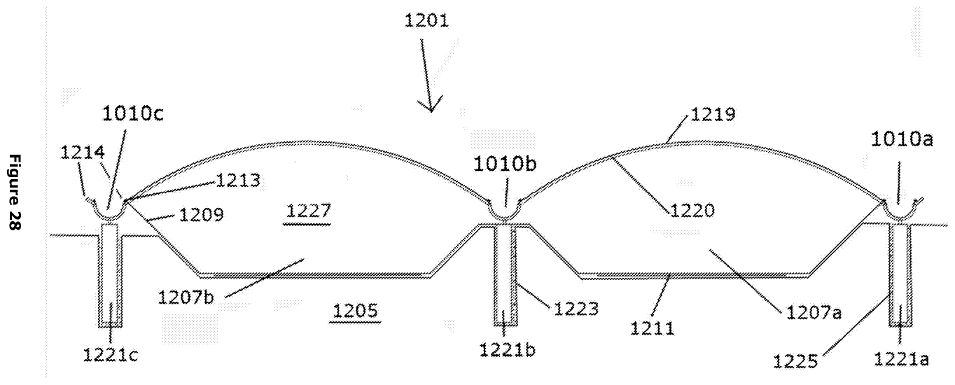

FIG. 29 shows a close up image of one of the arms 1303 of a gutter 1010 onto which a square tubular rail 1305 and a C-shaped receiving portion 1307 have been attached. In FIG. 29, the arm includes a plurality of holes 1309 to which the square tubular rail 1305 and the C-shaped receiving portion 1307 are screwed. Alternatively, the arm includes a plurality of holes 1309 to which the C-shaped receiving portion 1307 is screwed directly. A liner 1311 and cover 1313 are also shown.

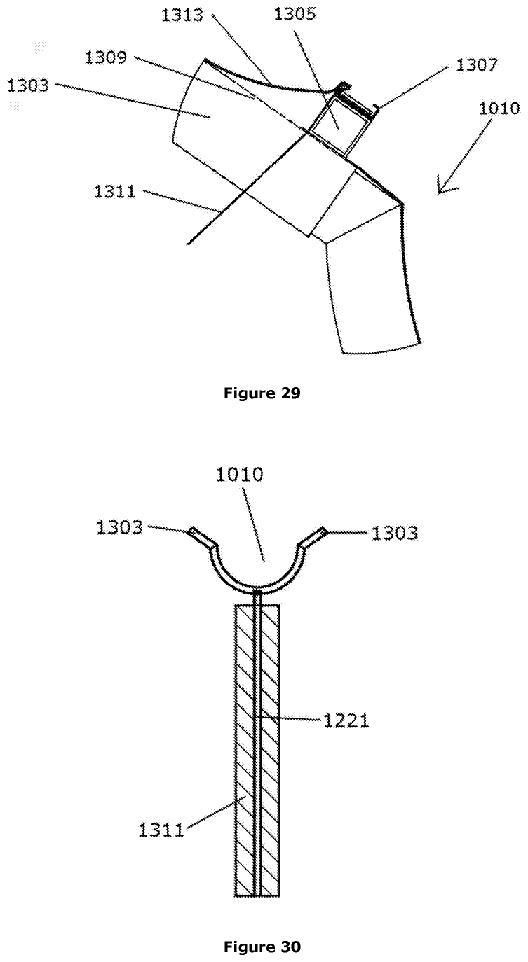

In FIG. 30, the gutter 1010 is shown equipped with two arms at either side 1303. The gutter 1010 is attached to a pillar 1221 embedded in the ground (not shown) and surrounded by concrete 1311.

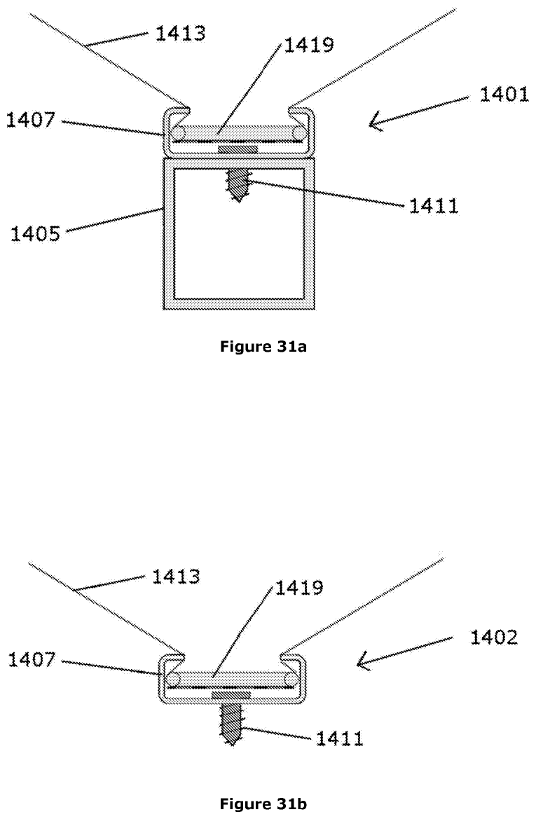

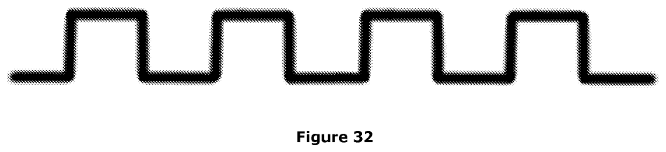

FIGS. 31a and 31b show cross sections through the interference-fit clips 1401, 1402. Whilst the C-shaped receiving portion 1407 of the interference-clip 1401 is screwed (by means of a screw 1411) to the square tubular rail 1405, said receiving portion 1407 may also be integral to the square tubular rail 1405 or otherwise affixed together, such as by welding. The cover 1413 (and/or liner, not shown) may be threaded into the C-shaped receiving portion 1407 of the interference-fit clip 1403 before being sandwiched in place between the C-shaped receiving portion 1407 and a fastener 1419 which is inserted into the C-shaped receiving portion 1407. Said fastener 1419 is usually an elongate fastener that runs the entire length of the elongate C-shaped receiving portion 1407. The elongate fastener has a square-wave profile (as shown in FIG. 32) and is fabricated from a resiliently deformable elastic material, usually made from steel or aluminium. The C-shaped receiving portion 1407 is typically made from aluminium. Both the cover 1413 (and/or liner, not shown) cooperate with the interference-fit clips 1401, 1402.

1. A greenhouse comprising:
A first sub-assembly, the first sub-assembly comprising:
a rail; and
a first clamping means;
the greenhouse further comprising;
a cover configured to at least partially allow light therethrough; and
a liner;
wherein the first sub-assembly, the cover and the liner cooperate with each other so as to form a closed system.

2. A greenhouse according to claim 1, wherein the first clamping means comprises;
a first receiving portion within the rail and
a first insert configured to be received in the first receiving portion.

3. A greenhouse according to claim 2, wherein the first receiving portion and the first insert cooperate by means of a snap-fit connection; or
wherein the first receiving portion and the first insert cooperate by means of an interference-fit connection.

4-6. (canceled)

7. A greenhouse according to claim 2, wherein the first receiving portion and the first insert are elongate.

8. A greenhouse according to claim 2, wherein the first sub-assembly further comprises a second clamping means spaced from the first clamping means.

9. A greenhouse according to claim 8, wherein the second clamping means comprises a second receiving portion in the rail and a second insert configured to be received in the second receiving portion.

10. A greenhouse according to claim 9, wherein the second receiving portion and the second insert cooperate by means of a snap-fit connection; or
wherein the first receiving portion and the first insert cooperate by means of an interference-fit connection.

11-13. (canceled)

14. A greenhouse according to claim 9, wherein the second receiving portion and the second insert are elongate.

15. (canceled)

16. A greenhouse according to claim 1, wherein at least a portion of the cover and the liner are clamped by the first clamping means.

17-19. (canceled)

20. A greenhouse according to claim 1, further comprising a truss.

21. (canceled)

22. A greenhouse according to claim 20, wherein the truss comprises;
a first anchoring member positioned at a first end of the greenhouse;
a second anchoring member at a second end of the greenhouse; and
a connection member suspended between the first and second anchoring members;
wherein, in use, the connection member cooperates with the cover in order to hold the cover in position.

23-24. (canceled)

25. A greenhouse according to claim 1, further comprising a supporting frame over or under which the cover can be stretched.

26-34. (canceled)

35. A greenhouse according to claim 1, wherein the rail further comprises an inner bar disposed between the first and a second clamping means, the inner bar comprising one or more inner bar features.

36. A greenhouse according to claim 35, wherein the inner bar further comprises one or more carriages, moveable along the inner bar, to which the one or more inner bar features may be affixed.

37. A greenhouse according to claim 35, wherein the inner bar comprises one or more inner bar features selected from the group consisting of: sensors, sprinklers, cameras, collection means, heat exchangers, lights or combinations thereof.

38. A greenhouse sub-assembly, the sub-assembly comprising:
a rail,
a first and a second clamping means, and
a bridging portion disposed between the first and second clamping means.

39. A greenhouse sub-assembly according to claim 38, wherein the first and the second clamping means each comprise a first and a second receiving portion each adapted to receive a first and a second insert respectively.

40. (canceled)

41. A greenhouse sub-assembly according to claim 38, wherein the bridging portion is adapted to promote condensation thereon.

42. (canceled)

43. A greenhouse sub-assembly according to claim 38, wherein the rail comprises a recess configured for to collect precipitation from the bridging portion.

44-52. (canceled)

53. A greenhouse comprising:
a cover configured to at least partially allow light therethrough; and
a liner; and
a first sub-assembly,
wherein the first sub-assembly comprises:
a plurality of means for holding the cover and/or liner in position; and
a first clamping means;
wherein the first sub-assembly, the cover and the liner cooperate with each other so as to form a closed system.
